(19) United States
(12) Patent Application Publication
(10) Pub. No.: US 2026/0261625 A1
(43) Pub. Date: Sep. 3, 2026

(54) CHANGING VIDEO OUTPUT BASED ON DETECTED OBJECTS

(71) Applicant: Motorola Mobility LLC, Chicago, IL (US)

(72) Inventors: Ranjeet Gupta, Aurora, IL (US); Rahul Bharat Desai, Hoffman Estates, IL (US); Philip Weinstein, Apex, NC (US)

(73) Assignee: Motorola Mobility LLC, Chicago, IL (US)

(21) Appl. No.: 19/066,995

(22) Filed: Feb. 28, 2025

(51) Int. Cl. H04N 5/272; H04N 23/45

(52) U.S. Cl. CPC H04N 5/272; H04N 23/45

(57) ABSTRACT

Changing video output based on detected objects is discussed herein. In a computing device, a background environment image is obtained using a first camera. An additional object in a field of view of the second camera is detected based at least in part on video captured by the second camera. Images of a user of the computing device are obtained using the first camera. Video that includes the images of the user overlaid on the background environment image is output based at least in part on detection of the additional object in the field of view of the second camera.

### BACKGROUND

As technology has advanced our uses for computing devices have expanded. One such use is video calls, which have become commonplace in home and business settings. However, current video call techniques are not without their problems. One such problem is unexpected interruptions. For example, family members inadvertently entering the camera's field of view or pets unexpectedly appearing in the background can be distracting to the users in the video call. These problems can be frustrating for users, leading to user frustration with their devices and video call systems.

### BRIEF DESCRIPTION OF THE DRAWINGS

Embodiments of changing video output based on detected objects are described with reference to the following drawings. The same numbers are used throughout the drawings to reference like features and components:

FIG. 1 illustrates an example system including a computing device implementing the techniques discussed herein;

FIG. 2 illustrates an example configuration of the computing device of FIG. 1;

FIG. 3 illustrates another example configuration of the computing device of FIG. 1;

FIG. 4 illustrates an example interruption alleviation system implementing the techniques discussed herein in accordance with one or more embodiments;

FIG. 5 illustrates an example of changing video output based on detected objects in accordance with one or more embodiments;

FIG. 6 illustrates an example of changing video output based on detected objects in accordance with one or more embodiments;

FIG. 7 illustrates an example process for implementing the techniques discussed herein in accordance with one or more embodiments;

FIG. 8 illustrates an example process for implementing the techniques discussed herein in accordance with one or more embodiments;

FIG. 9 illustrates an example process for implementing the techniques discussed herein in accordance with one or more embodiments;

FIG. 10 illustrates various components of an example electronic device that can implement embodiments of the techniques discussed herein.

### DETAILED DESCRIPTION

Changing video output based on detected objects is discussed herein. Generally, a computing device is used for a video call (e.g., a video conference), which refers to each of multiple computing devices that are part of the video call capturing video (e.g., a series of images or frames) of the user of the computing device and transmitting the video to the other computing devices that are part of the video call. Audio is also typically transmitted from each of the multiple computing devices to the other computing devices that are part of the video call. Using the techniques discussed herein, a computing device obtains a background environment image. The background environment image refers to the background behind the user during the video call. The background environment image is obtained, for example, by capturing one or more images (e.g., during the video call) and removing the user from those one or more images.

During the video call, the computing device captures video that includes both the user of the computing device and a portion of the background that is not obscured by the user, and transmits the video to one or more other computing devices that are part of the video call. In one or more implementations, the computing device includes and/or is coupled to two cameras, one camera with a narrower field of view (also referred to as the main camera) that captures a live video feed of the user and the background (also referred to as the main video feed) to be transmitted to other devices that are part of the video call, and another camera with a wider field of view (also referred to as an ultra-wide camera or a wide camera) for early detection of potential interruptions. The computing device transmits the live video feed of the user and the background captured by the main camera to one or more other computing devices that are part of the video call (e.g., using a video conferencing application or a video call application) while monitoring the images captured by the ultra-wide camera.

The computing device monitors (e.g., continuously) the field of view of the ultra-wide camera to detect any additional objects (e.g., persons or pets) entering the field of view of the ultra-wide camera. Upon detection of an additional object, the computing device automatically ceases transmitting the video captured by the main camera and instead transmits portions of the images that include the user captured by the main camera overlaid on the obtained background environment image. Once the detected object is no longer detected in the field of view of the ultra-wide camera, the computing device automatically reverts to transmitting the live video feed of the user and the background captured by the main camera to the one or more other computing devices that are part of the video call.

The computing device dynamically switches between transmitting the live video feed captured by the main camera and the portions of the images of the user captured by the main camera overlaid on the obtained background environment image. Accordingly, the techniques discussed herein provide an efficient, automated solution for alleviating background interruptions during video calls, without requiring manual intervention from the user. Furthermore, the use of multiple cameras with different fields of view allows early detection of potential interruptions before they enter the field of view of the main. This proactive approach, combined with the automatic application of a previously obtained background environment image with the user overlay, results in a smooth transition that is virtually imperceptible to other call participants.

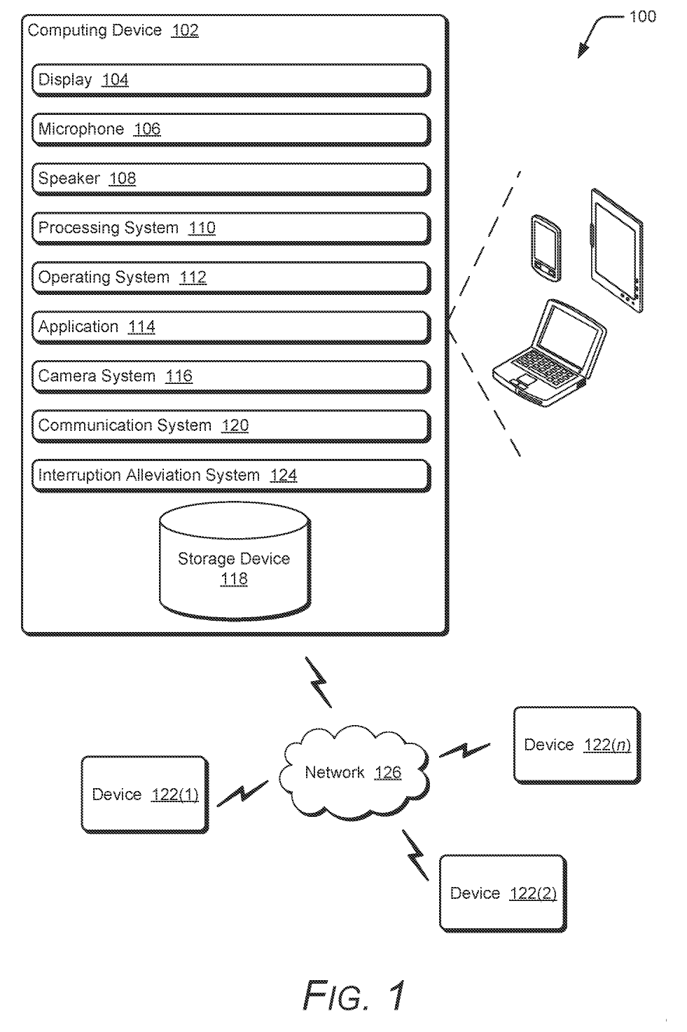

FIG. 1 illustrates an example system 100 including a computing device 102 implementing the techniques discussed herein. The computing device 102 can be, or include, many different types of computing or electronic devices. For example, the computing device 102 can be a smartphone or other wireless phone, a camera (e.g., compact or single-lens reflex), or a tablet or phablet computer. By way of further example, the computing device 102 can be a notebook computer (e.g., netbook or ultrabook), a laptop computer, an entertainment device (e.g., a gaming console, a portable gaming device, a streaming media player, a digital video recorder, a music or other audio playback device), a video camera, and so forth.

The computing device 102 includes a display 104, a microphone 106, and a speaker 108. The display 104 can be configured as any suitable type of display, such as an organic light-emitting diode (OLED) display, active matrix OLED display, liquid crystal display (LCD), in-plane shifting LCD, projector, and so forth. The microphone 106 can be configured as any suitable type of microphone incorporating a transducer that converts sound into an electrical signal, such as a dynamic microphone, a condenser microphone, a piezoelectric microphone, and so forth. The speaker 108 can be configured as any suitable type of speaker incorporating a transducer that converts an electrical signal into sound, such as a dynamic loudspeaker using a diaphragm, a piezoelectric speaker, non-diaphragm based speakers, and so forth.

Although illustrated as part of the computing device 102, it should be noted that one or more of the display 104, the microphone 106, and the speaker 108 can be implemented separately from the computing device 102. In such situations, the computing device 102 can communicate with the display 104, the microphone 106, or the speaker 108 via any of a variety of wired (e.g., Universal Serial Bus (USB), IEEE 1394, High-Definition Multimedia Interface (HDMI)) or wireless (e.g., Wi-Fi, Bluetooth, infrared (IR)) connections. For example, the display 104 may be separate from the computing device 102 and the computing device 102 (e.g., a streaming media player) communicates with the display 104 via an HDMI cable. By way of another example, the microphone 106 may be separate from the computing device 102 (e.g., the computing device 102 may be a television and the microphone 106 may be implemented in a remote control device) and voice inputs received by the microphone 106 are communicated to the computing device 102 via an IR or radio frequency wireless connection.

The computing device 102 also includes a processing system 110 that includes one or more processors, each of which can include one or more cores. The processing system 110 is coupled with, and may implement functionalities of, any other components or modules of the computing device 102 that are described herein. In one or more embodiments, the processing system 110 includes a single processor having a single core. Alternatively, the processing system 110 includes a single processor having multiple cores or multiple processors (each having one or more cores).

The computing device 102 also includes an operating system 112. The operating system 112 manages hardware, software, and firmware resources in the computing device 102. The operating system 112 manages one or more applications 114 running on the computing device 102 and operates as an interface between applications 114 and hardware components of the computing device 102. One example of an application 114 (or a program of the operating system 112) is a video call (e.g., a video conferencing) application or program that transmits video and audio of a user of the computing device to other computing devices, and that receives video and audio of users of other computing devices for display by the display 104 and/or playback by the speaker 108.

The computing device 102 also includes a camera system 116. The camera system 116 captures images digitally using any of a variety of different technologies, such as a charge-coupled device (CCD) sensor, a complementary metal-oxide-semiconductor (CMOS) sensor, combinations thereof, and so forth. The camera system 116 can include a single camera (e.g., a single sensor and lens), or alternatively multiple cameras (e.g., multiple sensors or multiple lenses). For example, the camera system 116 may have at least one lens and sensor positioned to capture images from the front of the computing device 102 (e.g., the same surface as the display is positioned on), and at least one additional lens and sensor positioned to capture images from the back of the computing device 102. By way of another example, the camera system 116 may have multiple lenses (each having a corresponding sensor or multiple lenses sharing a single sensor) positioned to capture images from the same side (e.g., front or back) of the computing device 102.

When the camera system 116 has multiple cameras, each of the cameras has an associated field of view, and the fields of view for different cameras can be different. Examples of cameras include a tele or telephoto camera system having the smallest field of view, an ultra-wide camera system having the largest field of view, and a normal or wide camera system having a field of view larger than the telephoto camera system but smaller than the ultra-wide camera system. This normal or wide camera system may also be referred to as the main camera for the computing device 102.

The camera system 116 can capture video (e.g., a series of images) as well as still images. The captured video and/or still images are optionally stored in a storage device 118. The storage device 118 can be implemented using any of a variety of storage technologies, such as magnetic disk, optical disc, Flash or other solid state memory, and so forth.

The computing device 102 also includes a communication system 120. The communication system 120 manages communication with various other devices, including establishing and maintaining video calls with other devices 122(1), …, 122(n), sending electronic communications to and receiving electronic communications from other devices, and so forth. The content of these electronic communications and the recipients of these electronic communications is managed by, for example, one or more of an application 114, the operating system 112, or an interruption alleviation system 124. This management of the content and recipients can include receiving images (e.g., video) from one or more of the other devices 122(1), …, 122(n), transmitting images (e.g., video) to one or more of the other devices 122(1), …, 122(n), selecting recipients for a video call, and so forth.

The devices 122(1), …, 122(n) can be any of a variety of types of devices, analogous to the discussion above regarding the computing device 102. The communication between the computing device 102 and the other devices 122(1), …, 122(n), can be carried out over a network 126, which can be any of a variety of different networks, including the Internet, a local area network (LAN), a public telephone network, a cellular network (e.g., a third generation (3G) network, a fourth generation (4G) network, a fifth generation (5G) network, other suitable radio access technologies beyond 5G (e.g., sixth generation (6G)), an intranet, other public or proprietary networks, combinations thereof, and so forth. The computing device 102 can thus communicate with other devices wirelessly and accordingly is also referred to as a wireless device.

The interruption alleviation system 124 outputs video for transmission to the devices 122(1), …, 122(n), e.g., as part of a video call. Although illustrated as separate from the applications 114 and the operating system 112, additionally, or alternatively, the interruption alleviation system 124 can be implemented as part of one or more applications 114 and/or one or more programs o the operating system 112.

During the video call, the camera system 116 captures video, also referred to as the main video feed, which includes both a user of the computing device and a portion of the background (e.g., the environment behind the user) that is not obscured by the user. The camera system 116 captures this video with a camera (e.g., a main camera) having a first field of view. The interruption alleviation system 124 also obtains a background environment image (e.g., an image of the environment behind the user during the video call captured using the first field of view) and an image of the user captured using the first field of view. The interruption alleviation system 124 obtains the background environment image in any of various manners as discussed in more detail below, such as by segmenting out the user from an image.

The interruption alleviation system 124 receives the main video feed from the camera system 116 and outputs the main video feed (e.g., to a video call application or program, or to the devices 122(1), …, 122(n) that are part of the video call). The interruption alleviation system 124 also monitors the video captured by the camera system 116 with a camera having a second field of view that is wider than the first field of view. The interruption alleviation system 124 automatically monitors the images captured in the second field of view to detect any additional objects (e.g., persons or pets) entering the second field of view. Upon detection of an additional object entering the second field of view, the interruption alleviation system 124 continues to receive the main video feed and extracts, e.g., from each image or frame of the video feed, the portion of the image or frame that includes the user (which may also be referred to as extracting the user from the image or the frame). However, the interruption alleviation system 124 does not output the main video feed. Instead, the interruption alleviation system 124 automatically switches to outputting (e.g., to a video call application or program, or to the devices 122(1), …, 122(n) that are part of the video call) the extracted portions of the images that include the user overlaid on the background environment image. Accordingly, any such additional object(s) that may move within the first field of view will not be included in video output by the interruption alleviation system 124. When the additional object(s) is no longer in the second field of view, the interruption alleviation system 124 automatically ceases transmitting the extracted portions of the images that include the user overlaid on the background environment image and resumes outputting the main video feed (e.g., to a video call application or program, or to the devices 122(1), …, 122(n) that are part of the video call).

The interruption alleviation system 124 can be implemented in any of a variety of different manners. For example, the interruption alleviation system 124 can be implemented as multiple instructions stored on computer-readable storage media and that can be executed by the processing system 110. Additionally, or alternatively, the interruption alleviation system 124 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth).

In one or more implementations, the interruption alleviation system 124 is automatically activated or invoked whenever a video call begins, is initiated, or is occurring. Additionally, or alternatively, user input can be received indicating whether the interruption alleviation system 124 is to be activated or invoked for video calls. Additionally, or alternatively, the interruption alleviation system 124 is activated or invoked in response to one or more other actions, such as detection (e.g., by an application 114 or a program of the operating system 110) that the computing device 102 is connected or coupled to an external monitor and the computing device 102 is docked and/or positioned at a stationary position.

In one or more implementations, the interruption alleviation system 124 operates independently of the video call application or program (e.g., an application 114 or a program of the operating system 112). The interruption alleviation system 124 intercepts the camera feed going into the video call application or program and outputs the live video feed the user overlaid on the background environment image to the video call application or program. Accordingly, the video call application or program without knowledge of what operations are being performed by the interruption alleviation system 124.

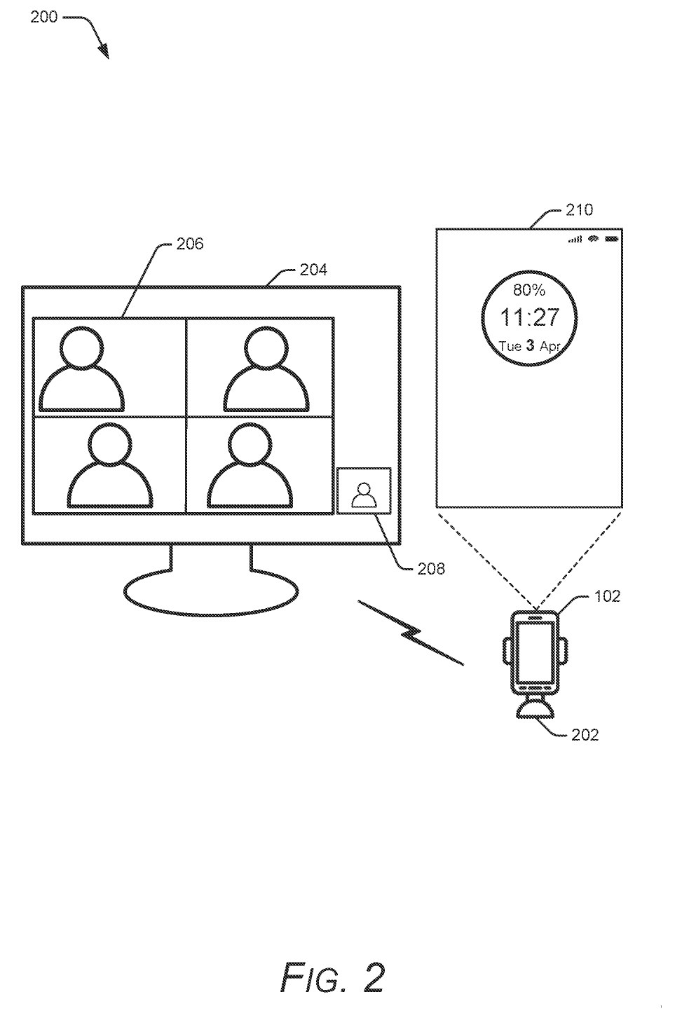

FIG. 2 illustrates an example configuration 200 of the computing device 102 of FIG. 1. The computing device 102 is mounted or positioned on a stand or dock 202 and communicates with a display 204 via a wired or wireless connection. The computing device 102 is managing a video call for a user of the computing device 102, and video of four other users participating in the video call are received from other computing devices (e.g., devices 122(1), …, 122(n) of FIG. 1) and displayed on the display 204 in a 2x2 grid 206. Video of the user of computing device 102 that is transmitted to the other computing devices (e.g., devices 122(1), …, 122(n)) is optionally displayed in a smaller block 208.

Lenses of the camera system 116 of the computing device 102 are positioned on the front of the computing device 102, so additional information is displayed on the display screen 210 of the computing device 102. For example, the display screen 210 can display various status information, such as the current time (11:27), the current date (Tue 3 Apr), the current battery level (80%), and a signal strength indicator.

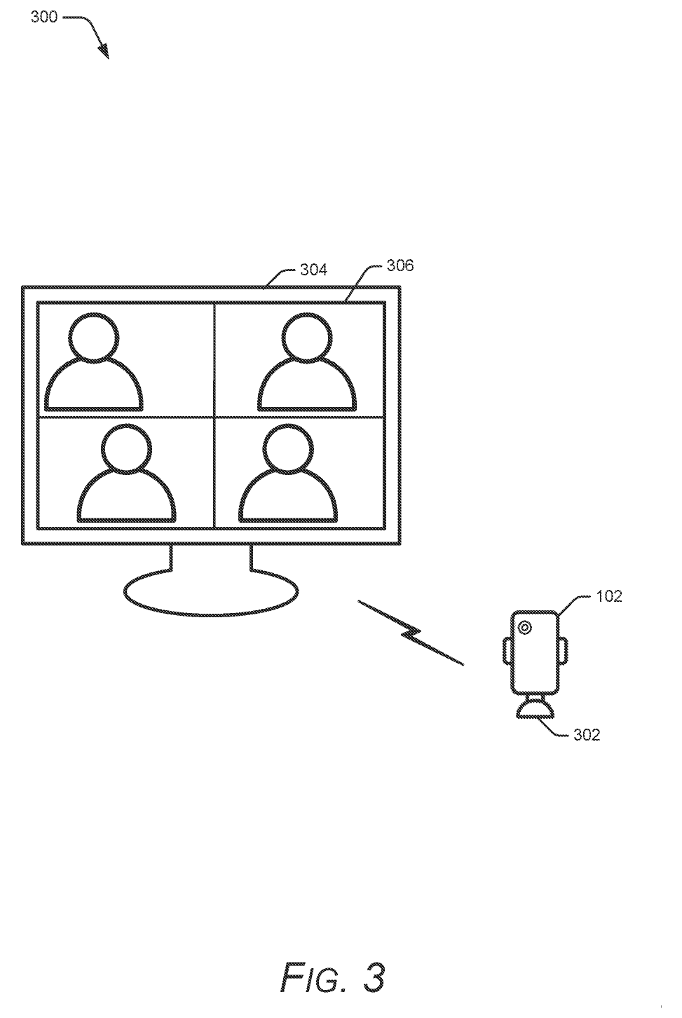

FIG. 3 illustrates another example configuration 300 of the computing device 102 of FIG. 1. The computing device 102 is mounted or positioned on a stand or dock 302 and communicates with a display 304 via a wired or wireless connection. Lenses of the camera system 116 of the computing device 102 are positioned on the back of the computing device 102. The computing device 102 is managing a video call for a user of the computing device 102, and video of four other users participating in the video call are received from other computing devices (e.g., devices 122(1), …, 122(n) of FIG. 1) and displayed on the display 304 in a 2x2 grid 306. Although video of the user of computing device 102 that is transmitted to the other computing devices (e.g., devices 122(1), …, 122(n)) may be displayed on the display 304, such video is not illustrated as being displayed in FIG. 3.

It should be noted that although FIGS. 2 and 3 illustrate examples where the computing device 102 is mounted or positioned on a stand or dock and communicates with an external display via a wired or wireless connection, the techniques discussed herein can also be used in a computing device 102 having its own display. For example, the techniques discussed herein can be implemented on a wireless phone or a laptop computer having a speaker, microphone, main camera, and ultra-wide camera.

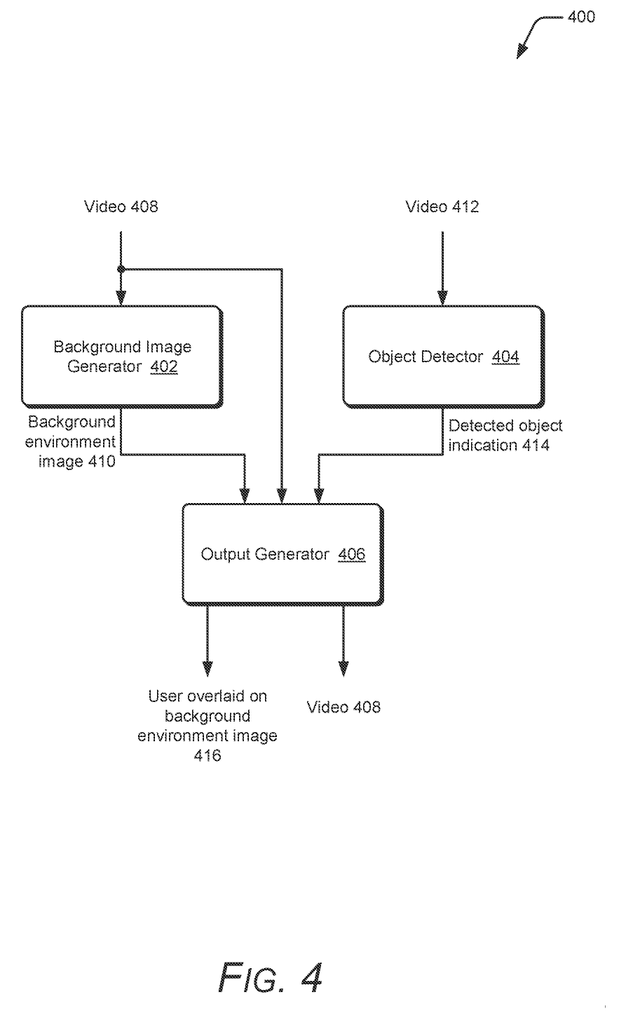

FIG. 4 illustrates an example interruption alleviation system 400 implementing the techniques discussed herein in accordance with one or more embodiments. The interruption alleviation system 400 can implement, for example, the interruption alleviation system 124 of FIG. 1. The interruption alleviation system 400 includes a background image generator 402, an object detector 404, and an output generator 406.

The background image generator 402 receives video 408 (e.g., a sequence of images or frames) that are captured by, for example, the main camera of the computing device 102. The background image generator 402 generates a background environment image 410 (e.g., the environment behind the user). The background image generator 402 generates the background environment image 410 in any of a variety of different manners. In one or more implementations, the main camera captures one or more images or frames of the video 408 while the user is in the field of view of the main camera and in response to, or just prior to, detection of an object by ultra-wide camera, discussed in more detail below.

The object detector 404 receives video 412 (e.g., a sequence of frames or images) that are captured from a camera having a wider field of view than the main camera. For example, the video 412 can be captured from an ultra-wide camera. The object detector 404 analyzes the video 412 to determine whether an additional object is in the video 412 (e.g., an additional object is within the field of view of the ultra-wide camera). The object detector 404 can determine whether an additional object is in the video 412 in any of a variety of different manners.

In one or more implementations, the object detector 404 receives an initial image or frame of video with the user and the background visible. The initial image or frame is, for example, an image or frame when capture of the video 408 began, a previously (e.g., immediately previous) image or The object detector 404 compares images or frames of the captured video 412 to the initial image and if there are any differences between the video 412 and the initial image, determine that an additional object is in the captured video 412. The initial image or frame can be, for example, an image or frame when capture of the video 408 began. Additionally, or alternatively, for each frame of the video 412 being analyzed, the initial image or frame can be a previous image or frame. For example, if the video 412 includes a sequence of images or frames A, B, C, D, E, F, with image or frame F being the image or frame being analyzed, the initial frame or image can be the immediately preceding frame in the sequence (frame E) or an earlier frame in the sequence (e.g., frame A).

The object detector 404 can, for example, perform this comparison of the images or frames of the captured video 412 to the initial frame(s) in only certain portions of the images or frames. For example, the object detector 404 can perform this comparison in portions of the images or frames that are captured by the ultra-wide camera but not the main camera, and not perform this comparison in a portion that is captured by both the ultra-wide camera and the main camera. This prevents the object detector 404 from determining that an additional object is in the captured video 412 due to movement of the user, which will be within the field of view of both the ultra-wide camera and the main camera.

Additionally, or alternatively, the object detector 404 receives an initial image or frame in the video 412 with the user and the background visible. The object detector 404 performs object detection or classification on the video 412 to determine whether a particular type or class of object, such as a person or an animal (e.g., a pet), that was not in the initial image is in the video 412. The object detector 404 can use an AI or machine learning model to detect and classify objects in the video 412. Classification models may may utilize deep learning models (e.g., neural networks, such as recurrent neural networks (RNNs) or convolutional neural networks (CNNs)). Classification AI models, when trained on diverse and extensive data, may readily identify and classify objects in images.

If the object detector 404 detects an additional object is in the video 412, the object detector 404 provides a detected object indication 414 to the output generator 406. The output generator 406 receives the video 408 and the background environment image 410. If the output generator 406 does not receive the detected object indication 414, then the 406 outputs the video 408. The output generator 406 can output the video 408 in various manners, such as providing the video 408 to a video call or video conference application or program (e.g., an application 114 or a program of the operating system 112), providing the video 408 to a communication system (e.g., the communication system 120 of FIG. 1) for transmission to one or more other devices, providing the video 408 to a display (e.g., the display 104 of FIG. 1), storing the video 408 (e.g., in the storage device 118 of FIG. 1), and so forth.

However, if the output generator 406 receives the detected object indication 414, the output generator 406 outputs images 416 with the user of the computing device 102 overlaid on the background environment image 410. The output generator 406 overlays the user on the background environment image 410 by extracting portions of the video 408 (e.g., using segmentation) that include the user and overlaying those images on the background environment image 410. This extraction of the user refers to identifying the portions of each of the images or frames in the video 408 that includes the user (e.g., only the user, or the user plus a small part (e.g., a few pixels) that does not include the user), and overlaying that portion on a corresponding portion of the background environment image 410. This corresponding portion can be specified in various manners, such as by identifying a location of the portion in an image or frame of the video 408 (e.g., relative to an edge or corner of the image or frame of the video 408, or relative to another object in an image or frame of the 408), and identifying a corresponding location in the background environment image 410.

It should be noted that the output generator 406 generates the images 416 using the same background environment image 410 but different extracted images of the users from the video 408. Accordingly, in the images 416 the movement of the user (e.g., eyes blinking, head moving, lips moving) in the video 408 is maintained even though the same background environment image 410 is used to generate the images 416.

In one or more implementations, the output generator 406 can use an AI or machine learning model to extract portions of the images or frames of the video 408 that include the user. Such AI models may utilize deep learning models (e.g., CNNs). Such AI models, when trained on diverse and extensive data, may readily identify portions of images that include the user.

It should be noted that overlaying the user on the background environment image 410 is seamless and typically not noticeable to other users (e.g., other users participating in the video call). When using the background environment image 410, movements by the user may result in blank or empty portions of the background environment image. For example, if the user moves his hand to the right, the previous location of the hand in the background environment image is blank or empty because the hand obscured the background. To resolve such situations, any of various image processing techniques can be used to fill in what would otherwise be blank or empty parts of the background environment image based on the values (e.g., colors, intensities) of the pixels around the blank area. Examples of such image processing techniques include patch-based algorithms, partial different equation-based methods, deep learning models (e.g., CNNs), and so forth.

In one or more implementations, the object detector 404 continues to provide the detected object indication 414 to the output generator 406 for as long as the object detector 404 detects an additional object is in the video 412. When the object detector 404 ceases providing the detected object indication 414 to the output generator 406, the output generator 406 ceases outputting the images 416 and resumes outputting the video 408.

Additionally, or alternatively, the object detector 404 may provide the detected object indication 414 to the output generator 406 for a shorter duration (e.g., provide the detected object indication 414 once then stop), and provide an additional indication (e.g., a “no object” indication or “return” indication) to the output generator 406 when the object detector 404 detects that an additional object is no longer in the video 412. The output generator 406, in response to this additional indication, ceases outputting the images 416 and resumes outputting the video 408.

Accordingly, the interruption alleviation system 400 automatically dynamically responds to objects detected within the field of view of the ultra-wide camera but not within the field of view of the main camera. When the interruption alleviation system 400 detects an object (e.g., a person or animal) entering the field of view of the ultra-wide camera, the output generator 406 can quickly switch from outputting live captured images to outputting composite images with the user overlaid on the background environment image. This ensures that distracting and/or embarrassing interruptions to the video call.

In one or more implementations, the ultra-wide camera is used to detect an additional object in the video 412 as discussed above. This allows the ultra-wide camera to be a lower resolution and lower performance (e.g., capture images or frames at a lower rate) than the main camera and thus conserving power in the computing device 102.

In one or more implementations, as discussed above, the images of the user to overlay on the background environment image are from the video 408 captured by the main camera. Additionally, or alternatively, in response to the object detector 404 detecting an additional object is in the video 412, the interruption alleviation system (e.g., the object detector 404 or the output generator 406) can power down or disable the main camera and the output generator 406 can extract the images of the user from the video 412 captured by the ultra-wide camera rather than from the video 408 captured by the main camera.

In one or more implementations, an ultra-wide camera may be used where the full field of view images are provided to the object detector 404 as video 412, but images with the edges cut or cropped off to the background image generator 402 as video 408.

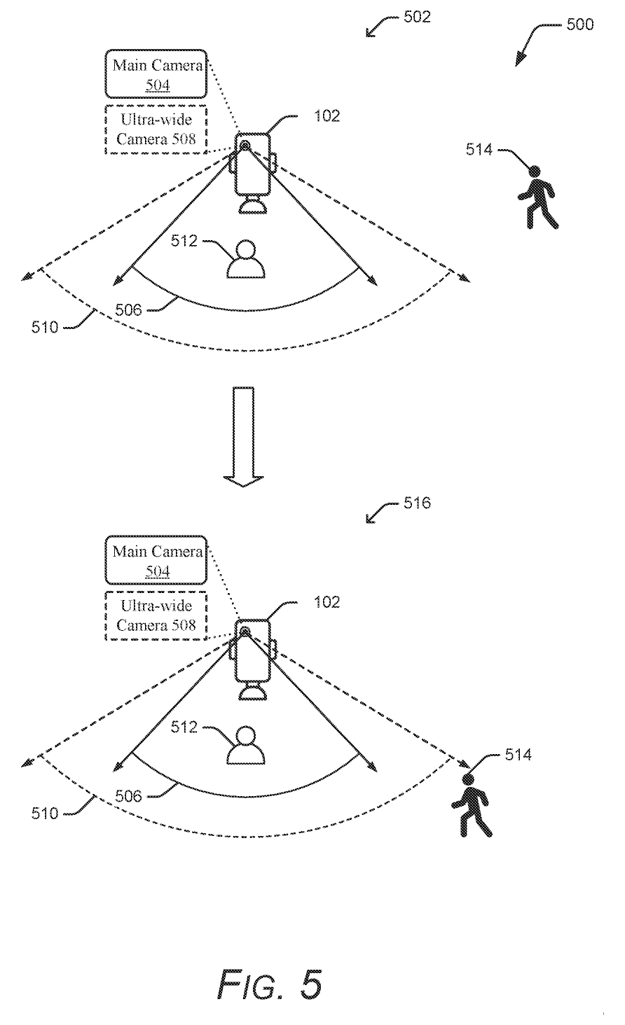

FIG. 5 illustrates an example 500 of changing video output based on detected objects in accordance with one or more embodiments. At 502, a computing device 102 (e.g., mounted or positioned on a stand), has a main camera 504 with a field of view 506 and an ultra-wide camera 508 with a field of view 510. As illustrated the field of view 510 is wider than the field of view 506. A user 512 is positioned in front of the computing device 102 within the field of view 506 and the field of view 510. The main camera 504, with the field of view 506, is used to capture images of the user 512 to be output (e.g., transmitted to a video call application or program, or to another device) for a video call. As illustrated at 502, another person 514 that is not part of the video call is starting to walk towards the field of view 506 of the main camera.

At 516, the other person 514 has entered the field of view 510 of the ultra-wide camera 504. In response to detecting the other person 514 in the field of view 510, the interruption alleviation system (e.g., the interruption alleviation system 124 of FIG. 1) outputs images of the user 512 overlaid on a background environment image. Thus, if the other person 514 continues walking and enters the field of view 506 of the main camera 504, the background environment image with the overlaid user will be output for the video call rather than the live video feed of the main camera 504 that will include the other person 514.

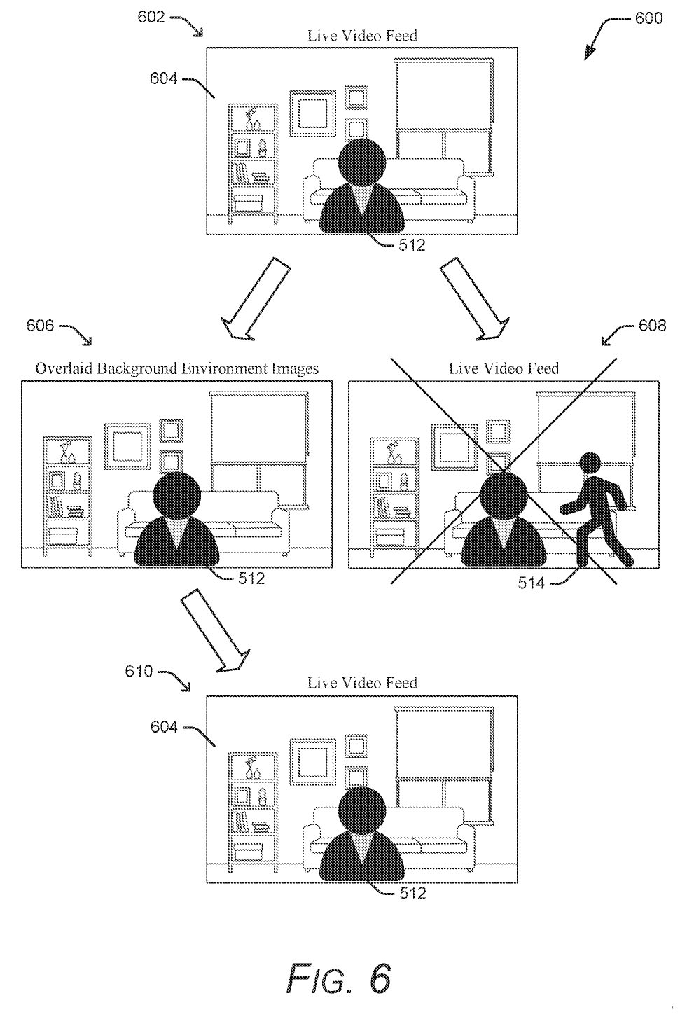

FIG. 6 illustrates an example 600 of changing video output based on detected objects in accordance with one or more embodiments. FIG. 6 is discussed with additional reference to FIG. 5. At 602, the live video feed (e.g., from the main camera 504), shows the user 512 with a background 604. At 606, the other person 514 has walked into the field of view 510 of the ultra-wide camera 504, so the interruption alleviation system (e.g., the interruption alleviation system 124 of FIG. 1) outputs images of the user 512 overlaid on a background environment image. If the live video feed had continued to be displayed, the other person 514 would have walked into the field of view 506 of the main camera 504, as illustrated at 608. Accordingly, outputting the images of the user 512 overlaid on a background environment image avoids outputting the live video feed that includes the other person 514.

At 610, the other person 514 is no longer detected in the field of view 510 of the ultra-wide camera 504, the interruption alleviation system reverts to outputting the live video feed.

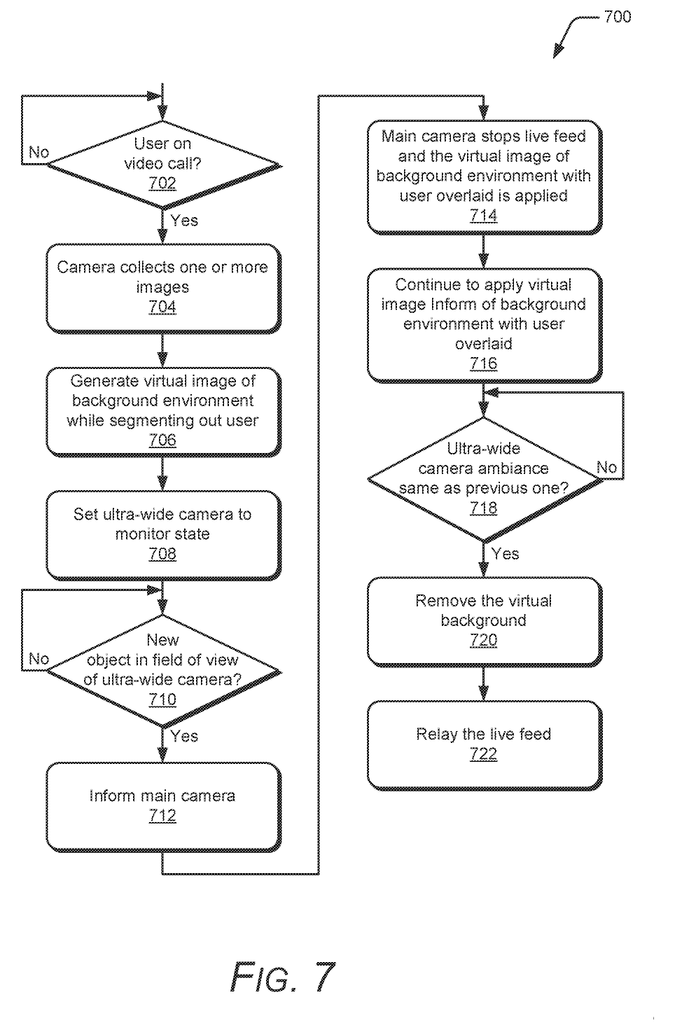

FIG. 7 illustrates an example process 700 for implementing the techniques discussed herein in accordance with one or more embodiments. At 702, a determination is made that a user is on a video call. In response to the user being on the video call, at 704 a camera captures or collets one or more images that include the user and the background of the user (e.g., the area behind the user). The camera that captures the images is, for example, a main camera (having a smaller field of view than an ultra-wide camera).

At 706, a background environment image is generated, which is, for example, a virtual image of the background environment (e.g., the area behind the user). The user is segmented out of the background environment image (e.g., extracted out from the image).

At 708, an ultra-wide camera is set to a monitor state. The ultra-wide camera has a wider field of view than the main camera.

At 710, the images captured by the ultra-wide camera are analyzed or monitored to detect when an object (e.g., another person or animal) comes within the field of view (or at least partially within the field of view) of the ultra-wide camera.

At 712, the main camera is informed of the detected object within the field of view of the ultra-wide camera, and at 714 the output (the live feed) of the main camera is stopped. Instead, images of the background environment image with the user (e.g., as captured by the main camera) overlaid are output.

At 716, the images of the background environment image with the user overlaid continue to be output until at 718 the ultra-wide camera ambiance is the same as before. This ultra-wide camera ambiance being the same as before refers to, for example, the object no longer being detected in the field of view of the ultra-wide camera (e.g., the ambiance (e.g., the background)) is the same as before the object was detected in the field of view of the ultra-wide camera at 710.

In response to the ultra-wide camera ambiance being the same as before, at 720 the virtual background is removed (e.g., output of the images of the background environment image with the user overlaid ceases) and at 722 the live feed is relayed (e.g., the images captured by the main camera are output).

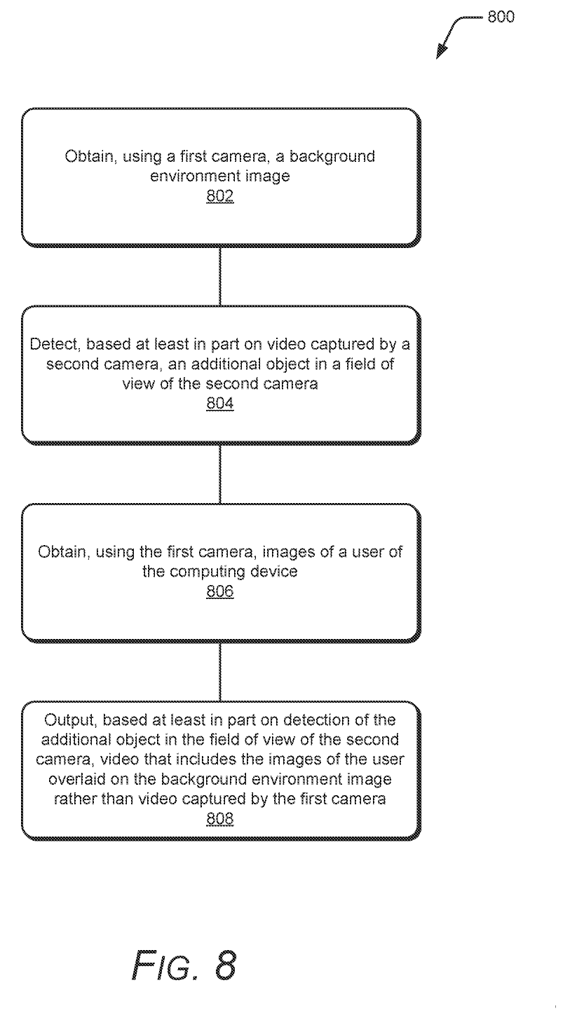

FIG. 8 illustrates an example process 800 for implementing the techniques discussed herein in accordance with one or more embodiments. Process 800 is carried out by one or more of an interruption alleviation system, a camera system, an application, or an operating system, such as the interruption alleviation system 124, the camera system 116, an application 114, or the operating system 112 of FIG. 1, and can be implemented in software, firmware, hardware, or combinations thereof. Process 800 is shown as a set of acts and is not limited to the order shown for performing the operations of the various acts.

In process 800, a background environment image is obtained using a first camera (act 802). The background environment image can be obtained from an image or frame captured by the first camera (e.g., a main camera) by removing (e.g., deleting, making black or another color) the portion of the image or frame that includes the user.

An additional object in a field of view of a second camera is detected based at least in part on video captured by a second camera (act 804). This additional object can be, for example, a person or an animal (e.g., a pet). The second camera (e.g., an ultra-wide camera) can have a wider field of view than the first camera.

Images of a user of the computing device are obtained using the first camera (act 806). These images of the user are obtained by extracting portions of the images or frames in the video captured by the first camera that include the user.

Video that includes the images of the user overlaid on the background environment image are output, based at least in part on detection of the additional object in the field of view of the second camera (act 808). This video that includes the images of the user overlaid on the background environment image is output rather than video captured by the first camera.

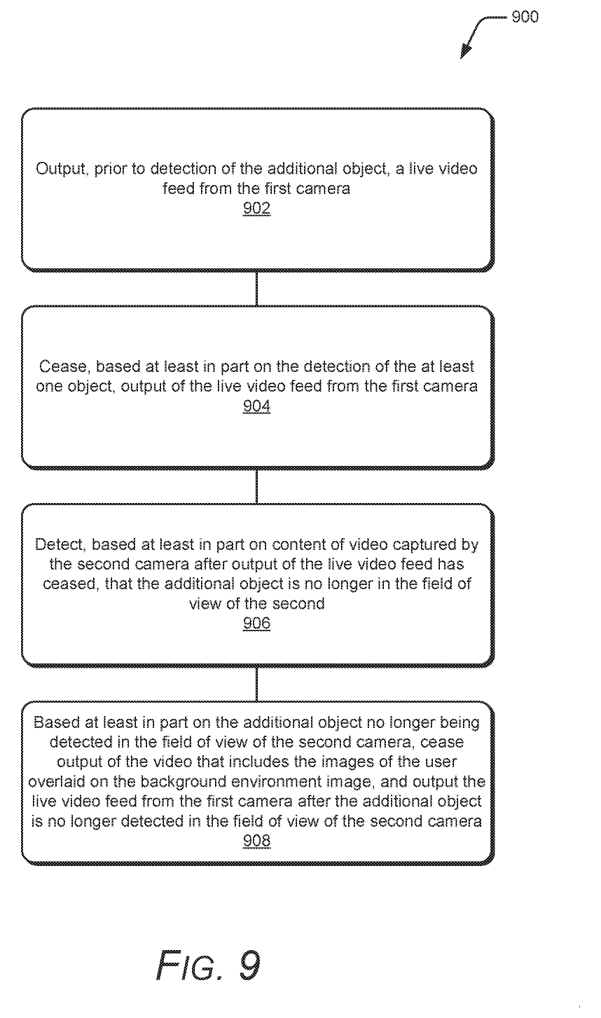

FIG. 9 illustrates an example process 900 for implementing the techniques discussed herein in accordance with one or more embodiments. Process 900 is carried out by one or more of an interruption alleviation system, a camera system, an application, or an operating system, such as the interruption alleviation system 124, the camera system 116, an application 114, or the operating system 112 of FIG. 1, and can be implemented in software, firmware, hardware, or combinations thereof. Process 900 is shown as a set of acts and is not limited to the order shown for performing the operations of the various acts.

In process 900, a live video feed from a first camera is output prior to detection of an additional object (act 902). The additional object is detected based at least in part on video captured by a second camera having a wider field of view than the first camera.

Output of the live video feed from the first camera is ceased, based at least in part on the detection of the at least one object (act 904). Instead, video that includes images of the user overlaid on a background environment image are output.

The additional object no longer being in the field of view of the second camera is detected, based at least in part on content of video captured by the second camera after output of the live video feed has ceased (act 906).

The live video feed from the first camera after the additional object is no longer detected in the field of view of the second camera is output based at least in part on the additional object no longer being detected in the field of view of the second camera (act 908). Output of the video that includes the images of the user overlaid on the background environment image is also ceased.

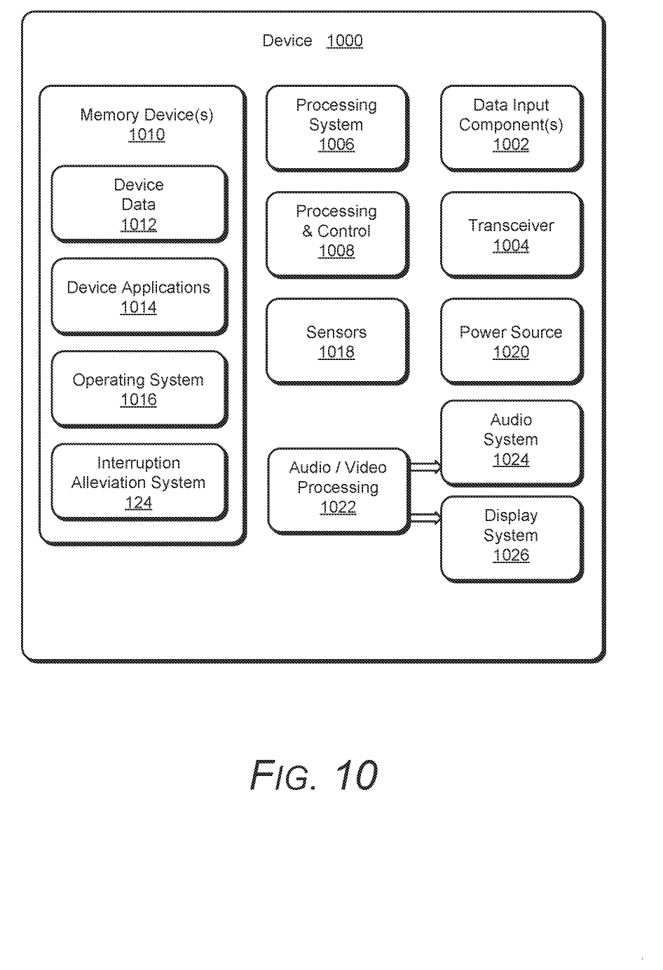

FIG. 10 illustrates various components of an example electronic device that can implement embodiments of the techniques discussed herein. The electronic device 1000 can be implemented as any of the devices described with reference to the previous FIG.s, such as any type of client device, mobile phone, tablet, computing, communication, entertainment, gaming, media playback, or other type of electronic device. In one or more embodiments the electronic device 1000 includes the interruption alleviation system 124, described above.

The electronic device 1000 includes one or more data input components 1002 via which any type of data, media content, or inputs can be received such as user-selectable inputs, messages, music, television content, recorded video content, and any other type of text, audio, video, or image data received from any content or data source. The data input components 1002 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 1002 may also include various other input components such as microphones, touch sensors, touchscreens, keyboards, and so forth.

The device 1000 includes communication transceivers 1004 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth^{TM}) standards, wireless local area network (WLAN) radios compliant with any of the various IEEE 802.11 (WiFi^{TM}) standards, wireless wide area network (WWAN) radios for cellular phone communication, wireless metropolitan area network (WMAN) radios compliant with various IEEE 802.15 (WiMAX^{TM}) standards, wired local area network (LAN) Ethernet transceivers for network data communication, and cellular networks (e.g., third generation networks, fourth generation networks such as LTE networks, or fifth generation networks).

The device 1000 includes a processing system 1006 of one or more processors (e.g., any of microprocessors, controllers, and the like) or a processor and memory system implemented as a system-on-chip (SoC) that processes computer-executable instructions. The processing system 1006 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 1008. The device 1000 may further include any type of a system bus or other data and command transfer system that couples the various components within the device. A system bus can include any one or combination of different bus structures and architectures, as well as control and data lines.

The device 1000 also includes computer-readable storage memory devices 1010 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 1010 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1000 may also include a mass storage media device.

The computer-readable storage memory device 1010 provides data storage mechanisms to store the device data 1012, other types of information or data, and various device applications 1014 (e.g., software applications). For example, an operating system 1016 can be maintained as software instructions with a memory device and executed by the processing system 1006 to cause the processing system 1006 to perform various acts. The device applications 1014 may also include a device manager, such as any form of a control application, software application, signal-processing and control module, code that is native to a particular device, a hardware abstraction layer for a particular device, and so on.

The device 1000 can also include one or more device sensors 1018, such as any one or more of an ambient light sensor, a proximity sensor, a touch sensor, an infrared (IR) sensor, accelerometer, gyroscope, thermal sensor, audio sensor (e.g., microphone), and the like. The device 1000 can also include one or more power sources 1020, such as when the device 1000 is implemented as a mobile device. The power sources 1020 may include a charging or power system, and can be implemented as a flexible strip battery, a rechargeable battery, a charged super-capacitor, or any other type of active or passive power source.

The device 1000 additionally includes an audio or video processing system 1022 that generates one or both of audio data for an audio system 1024 and display data for a display system 1026. In accordance with some embodiments, the audio/video processing system 1022 is configured to receive call audio data from the transceiver 1004 and communicate the call audio data to the audio system 1024 for playback at the device 1000. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

In the discussions herein, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Although embodiments of techniques for changing video output based on detected objects have been described in language specific to features or methods, the subject of the appended claims is not necessarily limited to the specific features or methods described. Rather, the specific features and methods are disclosed as example implementations of techniques for implementing changing video output based on detected objects. Further, various different embodiments are described, and it is to be appreciated that each described embodiment can be implemented independently or in connection with one or more other described embodiments. Additional aspects of the techniques, features, and/or methods discussed herein relate to one or more of the following:

What is claimed is:

1. A computing device comprising:
a first camera;
a second camera;
at least one memory; and
at least one processor coupled with the at least one memory and operable to cause the computing device to:
obtain, using the first camera, a background environment image;
detect, based at least in part on video captured by the second camera, an additional object in a field of view of the second camera;
obtain, using the first camera, images of a user of the computing device; and
output, based at least in part on detection of the additional object in the field of view of the second camera, video that includes the images of the user overlaid on the background environment image rather than video captured by the first camera.

2. The computing device of claim 1, wherein the at least one processor is further operable to cause the computing device to:
output, prior to detection of the additional object, a live video feed from the first camera;
cease, based at least in part on the detection of the at least one object, output of the live video feed from the first camera;
detect, based at least in part on content of video captured by the second camera after output of the live video feed has ceased, that the additional object is no longer in the field of view of the second camera; and
based at least in part on the additional object no longer being detected in the field of view of the second camera, cease output of the video that includes the images of the user overlaid on the background environment image, and output the live video feed from the first camera after the additional object is no longer detected in the field of view of the second camera.

3. The computing device of claim 1, wherein the first camera has a narrower field of view than the second camera.

4. The computing device of claim 2, wherein the additional object is not present in the field of view of the first camera.

5. The computing device of claim 1, wherein the additional object is not present in the background environment image.

6. The computing device of claim 1, wherein the additional object comprises a person or an animal.

7. The computing device of claim 1, wherein the at least one processor is further operable to cause the computing device to output the video that includes the images of the user overlaid on the background environment image by communicating the video that includes the images of the user overlaid on the background environment to a video conferencing application running on the computing device.

8. The computing device of claim 1, wherein the at least one processor is further operable to cause the computing device to output the video that includes the images of the user overlaid on the background environment image by transmitting the video that includes the images of the user overlaid on the background environment to one or more additional computing devices in a video call.

9. A method performed by a computing device, the method comprising:
obtaining, using a first camera, a background environment image;
detecting, based at least in part on video captured by a second camera, an additional object in a field of view of the second camera;
obtaining, using the first camera, images of a user of the computing device; and
outputting, based at least in part on detection of the additional object in the field of view of the second camera, video that includes the images of the user overlaid on the background environment image rather than video captured by the first camera.

10. The method of claim 9, further comprising:
outputting, prior to detection of the additional object, a live video feed from the first camera;
ceasing, based at least in part on the detection of the at least one object, output of the live video feed from the first camera;
detecting, based at least in part on content of video captured by the second camera after output of the live video feed has ceased, that the additional object is no longer in the field of view of the second camera; and
based at least in part on the additional object no longer being detected in the field of view of the second camera, ceasing output of the video that includes the images of the user overlaid on the background environment image, and output the live video feed from the first camera after the additional object is no longer detected in the field of view of the second camera.

11. The method of claim 9, wherein the first camera has a narrower field of view than the second camera.

12. The method of claim 10, wherein the additional object is not present in the field of view of the first camera.

13. The method of claim 9, wherein the additional object is not present in the background environment image.

14. The method of claim 9, wherein the additional object comprises a person or an animal.

15. The method of claim 9, further comprising outputting the video that includes the images of the user overlaid on the background environment image by communicating the video that includes the images of the user overlaid on the background environment to a video conferencing application running on the computing device.

16. The method of claim 9, further comprising outputting the video that includes the images of the user overlaid on the background environment image by transmitting the video that includes the images of the user overlaid on the background environment to one or more additional computing devices in a video call.

17. A system comprising:
at least one memory; and
at least one processor coupled with the at least one memory and operable to cause the system to:
obtain, using a first camera, a background environment image;
detect, based at least in part on video captured by a second camera, an additional object in a field of view of the second camera;
obtain, using the first camera, images of a user of the system; and
output, based at least in part on detection of the additional object in the field of view of the second camera, video that includes the images of the user overlaid on the background environment image rather than video captured by the first camera.

18. The system of claim 17, wherein the first camera has a narrower field of view than the second camera.

19. The system of claim 17, wherein the at least one processor is further operable to cause the system to:
output, prior to detection of the additional object, a live video feed from the first camera;
cease, based at least in part on the detection of the at least one object, output of the live video feed from the first camera;
detect, based at least in part on content of video captured by the second camera after output of the live video feed has ceased, that the additional object is no longer in the field of view of the second camera; and
based at least in part on the additional object no longer being detected in the field of view of the second camera, cease output of the video that includes the images of the user overlaid on the background environment image, and output the live video feed from the first camera after the additional object is no longer detected in the field of view of the second camera.

20. The system of claim 17, wherein the additional object comprises a person or an animal.
